(19) United States
(12) Patent Application Publication
(10) Pub. No.: US 2005/0237935 A1
(43) Pub. Date: Oct. 27, 2005

(54) System and method of efficiently providing packet data service in a UMTS system

(75) Inventors: Hee-Joon Chae, Seoul (KR); Jung-Hun Lee, Suwon-si (KR); Cheol Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/108,755

(22) Filed: Apr. 19, 2005

(30) Foreign Application Priority Data
Apr. 21, 2004 (KR) 2004-27452

(51) Int. Cl. H04L 12/26

(52) U.S. Cl. 370/232

(57) ABSTRACT

A system and method of controlling a data rate of a user equipment (UE) for a packet data service in a mobile communication system is provided. In the system and method, a radio access bearer (RAB) assignment request message comprising maximum rate information is received. The maximum rate information indicates a requested data rate for the packet data service. An initial data rate is set to the requested data rate, and it is determined whether the initial data rate is available by checking available resources. If the initial data rate is not available, it is determined whether the initial data rate is the lowest of a plurality of levels of predetermined data rates. If the initial data rate is the lowest level, a RAB is established in a common channel state. If the initial data rate is available, a RAB is established at the initial data rate in a dedicated channel state.

### PRIORITY

This application claims priority under 35 U.S.C. § 119 to an application entitled “Method of Efficiently Providing Packet Data Service in a UMTS System” filed in the Korean Intellectual Property Office on Apr. 21, 2004 and assigned Ser. No. 2004-27452, the entire contents of which are incorporated herein by reference.

### BACKGROUND OF THE INVENTION

1. Field of the Invention

The present invention relates generally to a system and method of providing a packet data service in a Universal Mobile Telecommunication System (UMTS) system. In particular, the present invention relates to a system and method of allocating a different data rate according to the amount of traffic in the UMTS.

2. Description of the Related Art

Mobile communication systems are generally divided into synchronous mobile communication systems and asynchronous mobile communication systems. The synchronous mobile communication systems include Code Division Multiple Access 1x (CDMA 1x) and Evolution-Data Only (EV-DO) which evolved from the IS-95 family of standards. The asynchronous mobile communication systems include Universal Mobile Telecommunication System (UMTS) which evolved from Global System for Mobile Telecommunication (GSM) and General Packet Radio Service (GPRS) which make use of Time Division Multiple Access (TDMA).

As CDMA mobile telephony has evolved, data rate transmission in a CDMA system has increased significantly, and many techniques are now under discussion to provide a variety of services to accommodate the higher data rates.

Diverse user demands are a driving force behind the provisioning of services such as wireless Internet, video phone service, Video On Demand (VOD), and Java 2 Micro Edition (J2MW). These services typically require a large storage capacity and are provided at high rates.

To provide such a high-rate packet data service, a synchronous system uses common channels and a UMTS system uses shared channels such as Downlink Shared Control Channel (DSCH) or High Speed-DSCH (HS-DSCH).

The UMTS system can also allocate one high-rate channel to an individual user depending on a Node B configuration or an operator's judgment.

The use of shared channels for packet data service can readily lead to a lack of the availability of codes and a lack of available power due to channels that deliver a large amount of data in the conventional UMTS system. Therefore, a call connection is denied for a new user, resulting in a decrease in the total system capacity.

Accordingly, a need exists for a method of efficiently providing a high-capacity, high-speed packet data service in a UMTS system that makes maximum use of available channel capacity.

### SUMMARY OF THE INVENTION

An object of the present invention is to substantially solve at least the above problems and/or disadvantages and to provide at least the advantages below. Accordingly, an object of the present invention is to provide a system and method of allocating a different data rate based on the amount of traffic in a wireless high-speed packet data communication system.

Another object of the present invention is to provide a system and method of selectively allocating a dedicated channel or a common channel according to the amount of user traffic.

The above objects are achieved by providing a system and method of efficiently providing a packet data service in a Universal Mobile Telecommunication System (UMTS) system.

According to one aspect of the present invention, in a system and method of controlling a data rate of a user equipment (UE) for a packet data service in a mobile communication system, a radio access bearer (RAB) assignment request message is received. It comprises maximum rate information indicating a data rate requested for the packet data service. An initial data rate is set to the requested data rate for the packet data service and it is determined whether the initial data rate is available by checking resources available for the packet data service. If the initial data rate is not available, it is determined whether the initial data rate is the lowest of a plurality of levels of predetermined data rates. If the initial data rate is the lowest level, a RAB is established in a common channel state for the packet data service. If the initial data rate is available, a RAB is established at the initial data rate in a dedicated channel state for the packet data service.

According to another aspect of the present invention, in a system and method of controlling a data rate of a UE for a packet data service in a mobile communication system, the amount of traffic on a RAB is measured during a packet data service through the RAB at a data rate selected among a plurality of levels of predetermined data rates in a dedicated channel state. If the traffic amount is less than a predetermined lower threshold for the selected data rate, a dedicated channel is released and the RAB is transitioned to a common channel state.

### BRIEF DESCRIPTION OF THE DRAWINGS

The above and other objects, features and advantages of the present invention will become more apparent from the following detailed description when taken in conjunction with the accompanying drawings in which:

FIG. 1 is a schematic view illustrating the configuration of a mobile communication system according to an embodiment of the present invention;

FIG. 2 exemplarily illustrates a plurality of levels of data rates according to an embodiment of the present invention;

FIG. 3 is a flowchart illustrating an operation for determining an initial data rate according to an embodiment of the present invention;

FIG. 4 is a flowchart illustrating an operation for changing a data rate according to a change in an amount of traffic according to an embodiment of the present invention; and

FIG. 5 is a flowchart illustrating an operation for changing a data rate during a packet service in progress in a CELL_FACH state according to an embodiment of the present invention.

Throughout the drawings, the same element is designated by the same reference numeral or character.

### DETAILED DESCRIPTION OF EXEMPLARY EMBODIMENTS

Embodiments of the present invention will be described herein below with reference to the accompanying drawings. In the following description, well-known functions or constructions are not described in detail for conciseness.

In general, the provisioning of a packet data service is divided largely into initial data rate determination and data rate changing during the service.

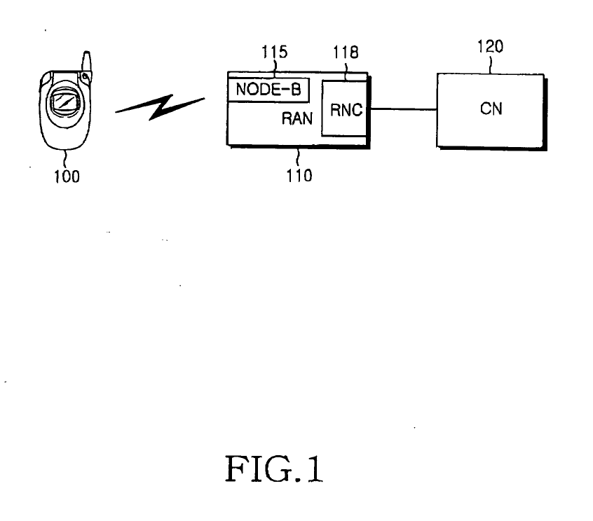

FIG. 1 is a schematic view illustrating the configuration of a mobile communication system according to an embodiment of the present invention. Referring to FIG. 1, the mobile communication system comprises a User Equipment (UE) 100, a Radio Access Network (RAN) 110 comprising a Node B 115 for connection to the UE 100 and a Radio Network Controller (RNC) 118, and a Core Network (CN) 120 for connecting the RAN 110 to a packet data network.

To provide the packet data service, a channel is allocated based on maximum rate information set between the CN 120 and the UE 100 in a call setup procedure and a Radio Access Bearer (RAB) is established between the UE 100 and the RAN 110. A decision as to an initial Radio Resource Control (RRC) state or an initial data rate for a particular call to provide the packet data service to is related to the radio overhead (power) of the cell. After the initial data rate is determined and the call is set up, the RRC state and the data rate are changed depending on the amount of traffic.

A description will now be made of a method of determining an initial data rate in a call setup procedure according to an embodiment of the present invention.

Upon a request for a call connection from the UE 110 to receive a packet data service, the CN 120 transmits a RAB assignment request message to the RAN 110. The RAB assignment request message comprises maximum rate information about a CN-requested data rate.

The RAN 110 determines an initial data rate by analyzing the maximum rate information. Specifically, the RAN 110 analyzes the availability of wired and wireless resources for allocation according to the requested data rate and determines whether the requested RAB can be established. That is, the RAN 110 determines the initial data rate for the packet data service by determining whether a cell to which resources are to be allocated has enough power, whether codes are available for allocation, and whether lub link resources are sufficient between the RNC 118 and the Node B 115.

Six levels of data rates are available for the packet data service: level 1 (384 Kbps), level 2 (256 Kbps), level 3 (144 Kbps), level 4 (128 Kbps), level 5 (64 Kbps), and level 6 (32 Kbps). Upper and lower thresholds of traffic amounts are set for each level. Therefore, the initial data rate is changed based on levels within the range of the six levels by comparing a change in the amount of traffic with the upper and lower thresholds of the six levels of data rates.

In determining the initial data rate, the RAN 110 starts with level 6 (32 Kbps) and selects the highest available data rate by comparing the amount of traffic with the upper and lower thresholds for each level. If the available data rate is below 32 Kbps, the call is established by setting the RRC state to a Forward Access Channel (CELL_FACH) state in order to use a common transport channel. In the CELL_FACH state, although the UE 100 is not connected to the RAN via a Dedicated Channel (DCH), the location of the UE is detected on a cell basis and the UE 100 receives only a common channel, FACH from a cell.

The RAN transmits data traffic on the FACH that is mapped onto a common physical channel to the UE 100 for which the call has been set up in the CELL_FACH state. If traffic increases in size and exceeds a predetermined threshold, the RAN 110 determines whether a Dedicated Physical Channel (DPCH) can be allocated to the UE 100. In the presence of power or code resources sufficient to allocate the DPCH, the RAN 110 transitions the RRC state of the UE to a CELL_DCH state and allocates the dedicated channel to the UE 100. The data rate and the RRC state are changed for the LE depending on the amount of traffic.

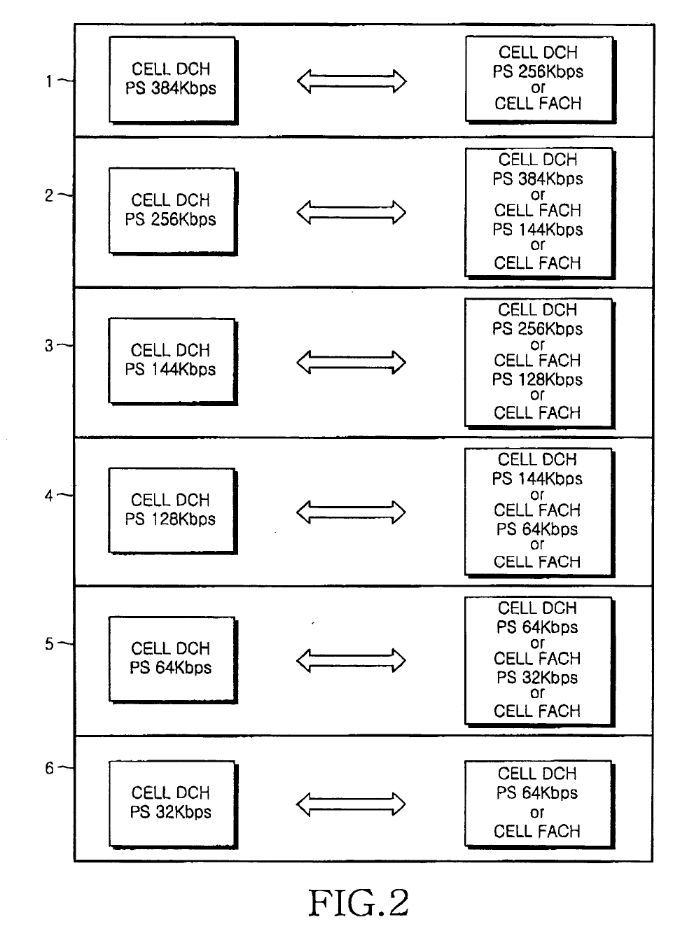

FIG. 2 is a table listing a plurality of levels of data rates according to an embodiment of the present invention.

Referring to FIG. 2, reference numeral 1 denotes a possible rate change in the case where a call is set up at level 1 (384 Kbps). If traffic increases above the upper threshold (Vol,upper_{—}384) of level 1 for a predetermined holding time while the traffic is delivered at 384 Kbps, the current rate, 384 Kbps is maintained. If the traffic amount decreases below the lower threshold (Vol,lower_{—}384) of level 1 for a predetermined holding time during traffic transmission at 384 Kbps, the current data rate is decreased by one level, thus to level 2.

If the traffic amount decreases below the lower threshold of level 6, the CELL_DCH state is transitioned directly to the CELL_FACH state without the above comparison.

Reference numeral 2 denotes a possible rate change in the case where a call is set up at level 2 (256 Kbps). If traffic increases above the upper threshold (Vol,upper_{—}256) of level 2 for a predetermined holding time while the traffic is delivered at 256 Kbps, the current rate is increased by one level, thus to level 1. If the traffic amount decreases below the lower threshold (Vol,lower_{—}256) of level 2 for a predetermined holding time during traffic transmission at 256 Kbps, the current data rate is decreased by one level, thus to level 3.

If the traffic amount decreases below the lower threshold of level 6, the CELL_DCH state is transitioned directly to the CELL_FACH state without the above traffic amount and threshold comparison.

Reference numeral 3 denotes a possible rate change in the case where a call is set up at level 3 (144 Kbps). If traffic increases above the upper threshold (Vol,upper_{—}144) of level 3 for a predetermined holding time while the traffic is delivered at 144 Kbps, the current rate is increased by one level, thus to level 2. If the traffic amount decreases below the lower threshold (Vol,lower_{—}144) of level 3 for a predetermined holding time during traffic transmission at 144 Kbps, the current data rate is decreased by one level, thus to level 4.

If the traffic amount decreases below the lower threshold of level 6, the CELL_DCH state is transitioned directly to the CELL_FACH state without the above traffic amount and threshold comparison.

Reference numeral 4 denotes a possible rate change in the case where a call is set up at level 4 (128 Kbps). If traffic increases above the upper threshold (Vol,upper_{—}128) of level 4 for a predetermined holding time while the traffic is delivered at 128 Kbps, the current rate is increased by one level, thus to level 3. If the traffic amount decreases below the lower threshold (Vol,lower_{—}128) of level 4 for a predetermined holding time during traffic transmission at 128 Kbps, the current data rate is decreased by one level, thus to level 5.

If the traffic amount decreases below the lower threshold of level 6, the CELL_DCH state is transitioned directly to the CELL_FACH state without the above traffic amount and threshold comparison.

Reference numeral 5 denotes a possible rate change in the case where a call is set up at level 5 (64 Kbps). If traffic increases above the upper threshold (Vol,upper_{—}64) of level 5 for a predetermined holding time while the traffic is delivered at 64 Kbps, the current rate is increased by one level, thus to level 4. If the traffic amount decreases below the lower threshold (Vol,lower_{—}64) of level 5 for a predetermined holding time during traffic transmission at 64 Kbps, the current data rate is decreased by one level, thus to level 6.

If the traffic amount decreases below the lower threshold of level 6, the CELL_DCH state is transitioned directly to the CELL_FACH state without the above traffic amount and threshold comparison.

Reference numeral 6 denotes a possible rate change in the case where a call is set up at level 6 (32 Kbps). If traffic increases above the upper threshold (Vol,upper_{—}32) of level 6 for a predetermined holding time while the traffic is delivered at 32 Kbps, the current rate is increased by one level, thus to level 5. If the traffic amount decreases below the lower threshold (Vol,lower_{—}32) of level 6 for a predetermined holding time during traffic transmission at 32 Kbps, the current data rate is maintained.

If the traffic amount decreases far below the lower threshold of level 6, the CELL_DCH state is transitioned directly to the CELL_FACH state without the above traffic amount and threshold comparison. When the traffic amount increases above a predetermined upper threshold for the CELL_FACH state (Vol,upper_CELL_FACH ) for a predetermined holding time in the CELL_FACH state, a data rate is set based on information about the rate set before the transition to the CELL_FACH state. If the traffic amount decreases below a predetermined lower threshold for the CELL_FACH state in the CELL_FACH state, the present RAB is preserved or released according to the mode in which the UE 100 is placed.

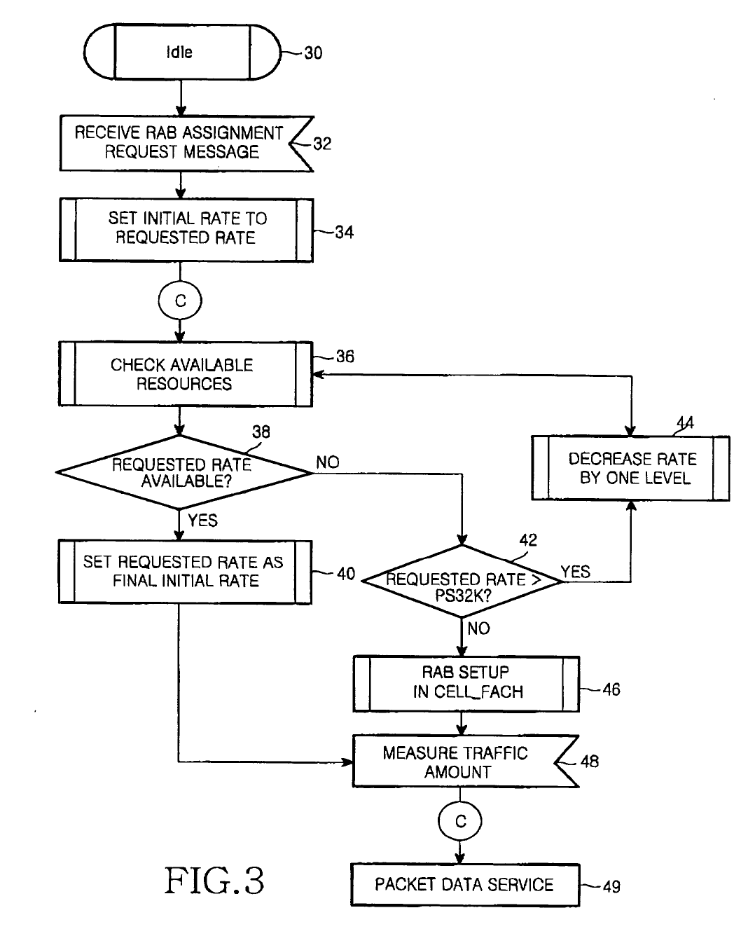

FIG. 3 is a flowchart illustrating an operation for determining an initial data rate according to an embodiment of the present invention.

Referring to FIG. 3, the UE 100 is in an idle state where a call is not yet set up in step 30. In step 32, the RAN 110 receives a RAB assignment request message for a packet data service from the CN 120. The RAB assignment request message comprises maximum rate information indicating a UE-requested data rate.

The RAN 110 sets the initial data rate to the requested data rate in step 34 and checks the availability of power, code and lub link resources to determine a final initial data rate in step 36.

In step 38, the RAN 110 compares the requested data rate with the available power and code resources. That is, the RAN 110 determines whether there are sufficient power, code and link resources to satisfy the requested data rate.

If the resources are sufficient, the RAN 110 determines the requested data rate to be the final initial data rate and establishes a RAB at the final data rate in a CELL_DCH state in step 40.

On the contrary, if the resources are insufficient, the RAN 110 compares the requested data rate with the lowest available data rate, 32 Kbps in step 42. If it is greater than 32 Kbps, the RAN 110 decreases the requested data rate by one level in step 44 and returns to step 36. If it is lower than 32 Kbps, the RAN 110 establishes a RAB in a CELL_FACH state in step 46.

After the RAB setup in step 40 or step 42, the RAN 110 measures the amount of traffic on the RAB periodically or each time transmission data is generated in step 48.

The traffic amount is compared with the upper and lower thresholds of each level and the initial data rate is changed according to the comparison result. If the traffic amount decreases significantly or below the lower threshold of the lowest data rate, the DCH is released and the UE 100 is transitioned to the CELL_FACH state in step 49.

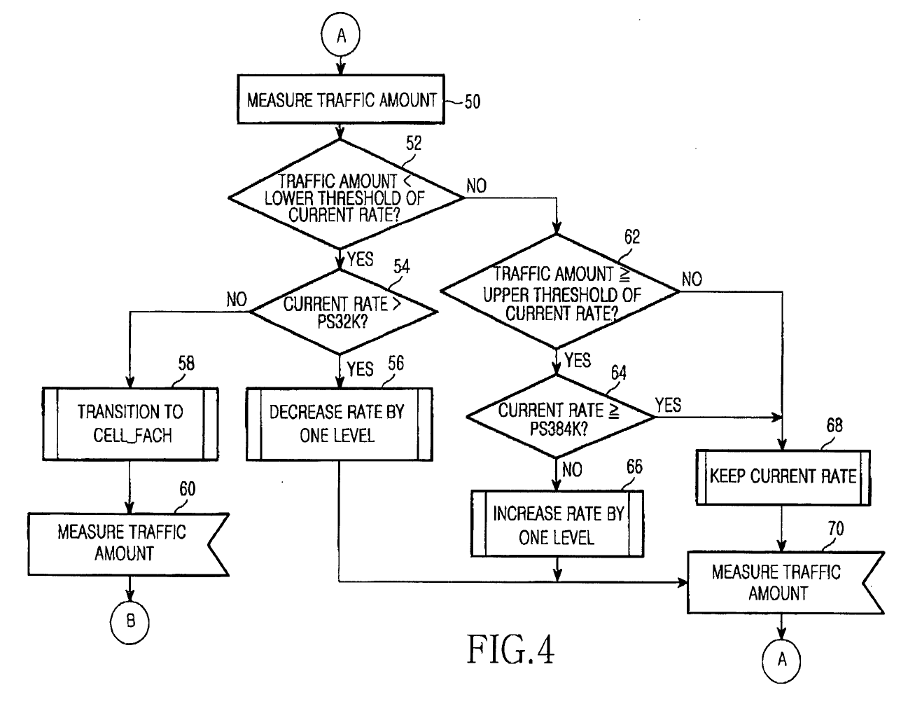

With reference to FIG. 4, a method of changing a data rate according to the change of traffic amount will be described below.

FIG. 4 is a flowchart illustrating an operation for changing a data rate according to a change in the amount of traffic according to an embodiment of the present invention.

Referring to FIG. 4, the RAN 110 measures the amount of traffic on the RAB in step 50 and compares the traffic amount with the lower threshold of the current data rate in step 52. If the traffic amount is less than the lower threshold of the current data rate, the RAN 110 determines whether the current data rate for the RAB is higher than level 6, 32 Kbps in step 54.

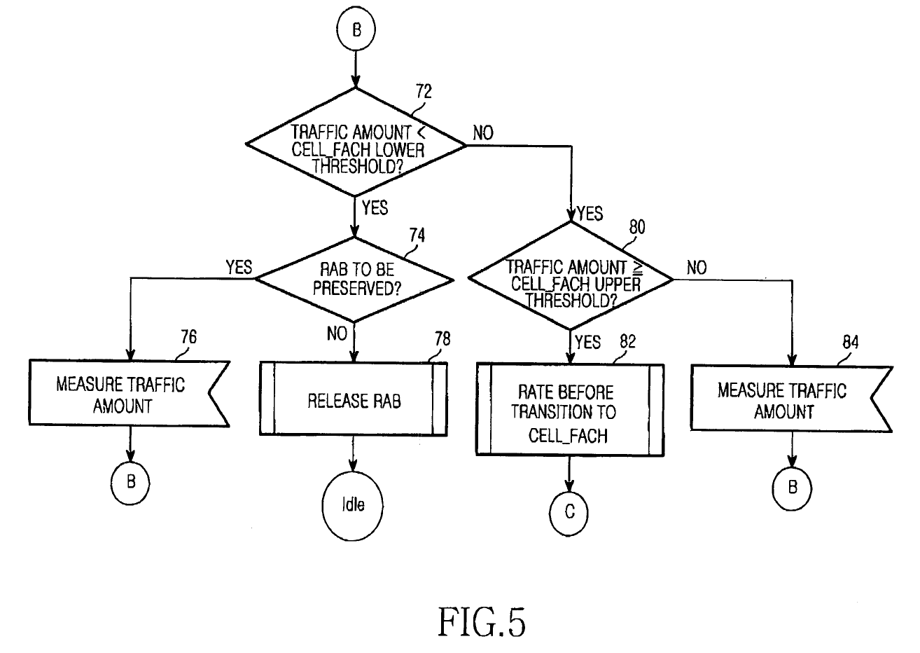

If the current data rate is less than or equal to 32 Kbps, the RAN 110 transitions the RRC state of the UE 100 to the CELL_FACH state in step 58 and goes to step 60. In the CELL_FACH state, the DCH is released and data is delivered on the FACH. In step 60, the RAN 110 measures the amount of traffic and goes to the procedure of FIG. 5.

On the contrary, if the current data rate is greater than 32 Kbps, the RAN 110 decreases the current data rate level by one level in step 56 and goes to step 70.

If the traffic amount is equal to or larger than the lower threshold of the current data rate in step 52, the RAN 110 compares the traffic amount with the upper threshold of the current data rate in step 62.

If the traffic amount is equal to or lager than the upper threshold of the current data rate, the RAN 110 determines whether the current data rate is level 1, 384 Kbps in step 64. If it is not 384 Kbps, the RAN 110 increases the current data rate by one level in step 66 and goes to step 70. If the current data rate is greater than or equal to 384 Kbps, the RAN 110 maintains the current data rate, 384 Kbps in step 68 and goes to step 70. If the traffic amount is less than the upper threshold of the current data rate in step 62, the RAN 110 goes to step 68.

In step 70, the RAN 110 measures the amount of traffic and returns to step 50.

FIG. 5 is a flowchart illustrating an operation for changing a data rate during a packet service in progress in the CELL_FACH state according to an embodiment of the present invention.

Referring to FIG. 5, the RAN 110 measures the amount of traffic on the RAB in step 60 of FIG. 4. In step 72, the RAN 110 compares the traffic amount with the lower threshold of the CELL_FACH state. If the traffic amount is less than the lower threshold of the CELL_FACH state, the RAN 110 determines whether to preserve or release the RAB in step 74. If the RAB is to be released, the RAN releases the RAB in step 78. If the RAB is to be preserved, the RAN 110 measures the amount of traffic on the RAB and reports the traffic amount in step 76.

On the other hand, if the traffic amount is equal to or larger than the lower threshold of the CELL_FACH state, the RAN 110 compares the traffic amount with the upper threshold of the CELL_FACH state in step 80. If the traffic amount is equal to or larger than the upper threshold of the CELL_FACH state, the RAN 110 acquires information about the previous rate before transitioning to the CELL_FACH state in step 82 and returns to step 36. On the contrary, if the traffic amount is less than the upper threshold of the CELL_FACH state, the RAN 110 measures the amount of traffic on the RAB in step 84 and returns to step 72.

By repeating the procedures of FIGS. 3, 4 and 5, the initial data rate set at a call setup is changed based on data rate levels according to the amount of traffic.

As described above, the present invention determines a data rate according to the amount of traffic. Therefore, resources taken for data transmission at a data rate determined irrespective of traffic amount can be saved. Also, radio resources are efficiently used and a decrease in system capacity can be prevented, while accommodating a sufficient number of users. Specifically, provisioning of a packet data service on the FACH with the DCH released reduces a loss in resources including power and codes.

While the invention has been shown and described with reference to certain embodiments thereof, it will be understood by those skilled in the art that various changes in form and details may be made therein without departing from the spirit and scope of the invention as defined by the appended claims.

1. A method of controlling a data rate of a user equipment (UE) for a packet data service in a mobile communication system, comprising the steps of:
(1) receiving a radio access bearer (RAB) assignment request message comprising maximum rate information indicating a data rate requested for the packet data service;
(2) setting an initial data rate for the packet data service to the requested data rate;
(3) determining whether the initial data rate is available by determining resources available for the packet data service;
(4) determining whether the initial data rate is the lowest of a plurality of levels of predetermined data rates if the initial data rate is not available;
(5) establishing a RAB in a common channel state for the packet data service if the initial data rate is the lowest level; and
(6) establishing a RAB at the initial data rate in a dedicated channel state for the packet data service if the initial data rate is available.

2. The method of claim 1, further comprising the step of, if the initial data rate is not the lowest level, decreasing the initial data rate by one level and returning to step (3).

3. The method of claim 1, wherein the resources comprise available power, codes, and link resources between a radio access network (RAN) and a core network (CN) available for the packet data service at the requested data rate.

4. The method of claim 1, wherein the common channel comprises a forward access channel (FACH) mapped onto a secondary common control physical channel (S_CCPCH).

5. The method of claim 1, wherein the plurality of levels of data rates comprise 32 Kbps, 64 KBps, 128 Kbps, 144 Kbps, 256 Kbps, and 384 Kbps.

6. A method of controlling a data rate of a user equipment (UE) for a packet data service in a mobile communication system, comprising the steps of:
measuring the amount of traffic on a radio access bearer (RAB) during a packet data service through the RAB at a data rate selected from among a plurality of levels of predetermined data rates in a dedicated channel state; and
releasing a dedicated channel and transitioning the RAB to a common channel state if the traffic amount is less than a predetermined lower threshold for the selected data rate.

7. The method of claim 6, wherein the transitioning step comprises the steps of:
determining whether the selected data rate is the lowest of the plurality of levels of data rates if the traffic amount is less than the lower threshold for the selected data rate;
decreasing the selected data rate by one level if the selected data rate is not the lowest level; and
releasing the dedicated channel and transitioning the RAB to the common channel state if the selected data rate is the lowest level.

8. The method of claim 6, further comprising the steps of:
determining whether the traffic amount is equal to or larger than a predetermined upper limit for the selected data rate, if the traffic amount is equal to or larger than the lower threshold for the selected data rate;
maintaining the selected data rate if the traffic amount is less than the upper limit for the selected data rate;
determining whether the selected data rate is the highest level, if the traffic amount is equal to or larger than the upper threshold for the selected data rate;
increasing the selected data rate by one level if the selected data rate is not the highest level; and
maintaining the selected data rate if the selected data rate is the highest level.

9. The method of claim 6, further comprising the steps of:
measuring the amount of traffic on the RAB after the transition to the common channel state;
preserving or releasing the RAB according to a preset mode value, if the traffic amount is less than a predetermined lower threshold for the common channel state;
comparing the traffic amount with a predetermined upper threshold for the common channel state if the traffic amount is equal to or larger than the lower threshold for the common channel state; re-establishing the RAB at a data rate set before the transition to the common channel state, if the traffic amount is equal to or larger than the upper threshold for the common channel state; and
maintaining the RAB in the common channel state, if the traffic amount is equal to or larger than the lower threshold for the common channel state and less than the upper threshold for the common channel state.

10. The method of claim 6, wherein the plurality of levels of data rates comprise 32 Kbps, 64 KBps, 128 Kbps, 144 Kbps, 256 Kbps, and 384 Kbps.

11. The method of claim 6, wherein the common channel comprises a forward access channel (FACH) mapped onto a secondary common control physical channel (S_CCPCH).

12. A system for adjusting a data rate of a user equipment (UE) in real-time for a packet data service in a mobile communication system, comprising:
a core network for receiving a radio access bearer (RAB) assignment request message comprising maximum rate information indicating a data rate requested for the packet data service from the UE; and
a radio access network (RAN) for receiving a RAB assignment message from the CN, setting an initial data rate for the packet data service to the requested data rate, determining whether the initial data rate is available by determining resources available for the packet data service, determining whether the initial data rate is the lowest of a plurality of levels of predetermined data rates if the initial data rate is not available, establishing a RAB in a common channel state for the packet data, establishing a RAB in a common channel state for the packet data service if the initial data rate is the lowest level and establishing a RAB at the initial data rate in a dedicated channel state for the packet data service if the initial data rate is available.

13. The system of claim 12, wherein the RAN decreases the initial data rate by one level if the initial data rate is not the lowest level.

14. The system of claim 12, wherein the resources comprises available power, codes, and link resources between the RAN and the CN available for the packet data service at the requested data rate.

15. The system of claim 12, wherein the resources comprise available power, codes, and link resources between a radio network controller (RNC) and a Node B available for the packet data service at the requested data rate.

16. The system of claim 12, wherein the common channel comprises a forward access channel (FACH) mapped onto a secondary common control physical channel (S_CCPCH).

17. The system of claim 12, wherein the plurality of levels of data rates comprise 32 Kbps, 64 KBps, 128 Kbps, 144 Kbps, 256 Kbps, and 384 Kbps.

18. The system of claim 12, wherein the RAN provides an upper threshold and a lower threshold within each level.

19. The system of claim 18, wherein the RAN selectively adjusts a current data rate to a new level based on the current data rate being greater than the upper threshold or less than the lower threshold.

20. The system of claim 12, wherein the RAN maintains a current level if a current data rata is greater than 384 kbps or less than 32 kbps.
